(19) United States
(12) Patent Application Publication
(10) Pub. No.: US 2014/0133944 A1
(43) Pub. Date: May 15, 2014

(54) Detection System Usable In Forklift Apparatus

(71) Applicants: John Alan Pangrazio, Island Lake, IL (US); Robert Thomas Pangrazio, Hudson, OH (US)

(72) Inventors: John Alan Pangrazio, Island Lake, IL (US); Robert Thomas Pangrazio, Hudson, OH (US)

(73) Assignee: LTS SCALE COMPANY, LLC, TWINSBURG, OH (US)

(21) Appl. No.: 14/077,667

(22) Filed: Nov. 12, 2013

Related U.S. Application Data
(60) Provisional application No. 61/725,180, filed on Nov. 12, 2012.
(60) Provisional application No. 61/885,552, filed on Oct. 2, 2013.

(51) Int. Cl. B66F 17/00; B66F 9/07; B66F 9/14

(52) U.S. Cl. CPC B66F 17/003; B66F 9/14; B66F 9/07
USPC 414/667; 701/50

(57) ABSTRACT

A detection system is usable on a vehicle such as a forklift. The detection system includes a sensor apparatus and a processor apparatus that are configured to detect the proximity of objects and structures that are situated in the vicinity of the forklift, and are further configured to initiate some type of action if the processor apparatus determines that the likelihood of a collision has reached a predetermined threshold. In the event of a collision determination, the processor apparatus outputs a collision signal to an output apparatus that performs any one or more of a variety of predetermined operations responsive to the collision signal. The operations can include reducing an engine speed of the forklift, reducing the velocity of the forklift, operating a movement mechanism to move the forklift platform away from the object or structure, producing audible and/or visual indications of the potential for a collision, and the like.

### CROSS-REFERENCE TO RELATED APPLICATIONS

The instant application claims priority from U.S. Provisional Patent Application Ser. No. 61/725,180 filed Nov. 12, 2012, and U.S. Provisional Patent Application Ser. No. 61/885,552 filed Oct. 2, 2013, the disclosures of which are incorporated herein by reference.

### BACKGROUND

1. Field

The disclosed and claimed concept relates generally to transportation equipment and, more particularly, to a collision detection system that is usable on a forklift or other transportation vehicle.

2. Related Art

Numerous types of material handling equipment are known. One type of material handling machine is a transport vehicle that is usable to move objects from one location to another. Once such type of transportation vehicle is a forklift, which is likewise well understood in the relevant art. Forklifts are often used to move objects from one location to another and typically include a platform that includes a set of forks that are configured to engage objects and lift them from a floor, by way of example, and is further usable to transport the lifted object from one location to another as needed. Forklifts are used extensively in shipping applications, such as for the loading and unloading of trucks, and are further used extensively in storage applications wherein objects are moved to and from storage locations and other locations within a facility. While such forklifts have been generally effective for their intended purposes, they have not been without limitation.

It is understood that the floors of trucks and the floors of loading docks are not always coplanar with one another, and loading docks thus typically include a dock leveler which is in the form of a movable ramp that extends from approximately an edge of the loading dock and that can be extended outward from the loading dock and angled upward or downward in order to reach the floor of the truck. The combined geometry of a truck bed, an angled or ramped dock leveler, and a loading dock floor, when further combined with a forklift having spaced front and rear wheels and a platform protruding from the front of the forklift beyond the front wheels, can sometimes require an operator to raise or lower the platform in order to clear the floor of the truck or the ramped dock leveler or the floor of the loading dock when traversing an angled dock leveler. For example, if the truck bed is situated below the loading dock, and if the forklift is to backed out of the truck and onto the angled dock leveler that extends therebetween, an operator of the forklift may need to raise the platform at the point at which the rear wheels begin to climb up the upwardly-angled dock leveler (with the front wheels still situated on the floor of the truck bed) in order to avoid the platform and/or the object carried on the platform from hitting the floor of the truck bed. That is, the rear wheels riding up an inclined dock leveler can cause the forklift to pitch generally forward about the front wheels, thus necessitating an increase in the vertical position of the platform in order to clear the floor of the truck. In such a circumstance, the platform typically will be raised to a higher position that would otherwise be required if the forklift were situated on a horizontal floor. Thereafter, when the rear wheels reach the floor of the loading dock (while the front wheels are still situated on the angled dock leveler) the forklift will begin to pitch generally rearward about the front wheels since the rear wheels are moving horizontally and the front wheels are traveling upward along the angled dock leveler. Such rearward pitching of the forklift when the platform is already raised higher than would be required for horizontal travel with the forklift results in the platform being elevated to an undesirably high vertical position above the angled dock leveler.

As is generally understood in the relevant art, the platform of a forklift is typically elevated only as much as is needed to permit the object to be transported by the forklift Such minimization of the lifting of an object carried on the forklift is desirable in order to avoid the forklift from becoming unstable due to a highly elevated load and potentially tipping over, either laterally or in the forward or rearward directions. In order to minimize the vertical position of a load during transport across an angled dock leveler, an operator of the forklift may lower the platform once the rear wheels have reached the loading dock and the forklift begins to pitch rearward. Such lowering may be instinctive for the operator who typically tries to carry the object on the platform at the lowest vertical position possible in order to avoid tipping of the forklift. However, since the forklift in such a condition is at least partially situated on an angled dock leveler, the actual vertical position of the platform with respect to the other portions of the forklift may be unclear to the operator, and the operator thus may potentially lower the platform while on the angled dock leveler to a position vertically below that at which the platform or the pallet carried thereon could ordinarily clear a horizontal floor. That is, the operator typically will not be aware that the platform is too low since the forklift is partially situated on an angled dock leveler and partially situated on, say, a floor of a loading dock. If the platform is situated too low, the platform can potentially strike the angled dock leveler or the edge of the loading dock when the front wheels reach the loading dock and the forklift pivots back to a generally horizontal orientation. Such a strike is undesirable because the platform and/or the object or load thereon can be ripped from the forklift.

Furthermore, it is understood that certain forklifts may additionally include a translation mechanism whereby the platform is additionally movable in a lateral or side-to-side direction (in addition to the lifting direction) for various desirable reasons. However, such a translation mechanism can translate the platform to a position wherein it laterally protrudes from the side of the forklift. When the forklift is being moved in a rearward direction with the platform laterally protruding from the other portions of the forklift, a potential exists that the platform can potentially strike an object or structure which was cleared by the forklift chassis, but which is struck by the laterally protruding portion of the platform. Such collisions are likewise undesirable due to the potential for damage to the forklift and/or the object carried on the platform.

It thus would be desirable to provide improvements that overcome these and other shortcomings known in the relevant art.

### SUMMARY

Accordingly, an improved detection system is usable on a transportation vehicle such as a forklift. The detection system includes a sensor apparatus and a processor apparatus that are configured to detect the proximity of objects and structures that are situated in the vicinity of the forklift, and are further configured to initiate some type of action if the processor apparatus determines that the likelihood of a collision has reached a predetermined threshold. In the event of such a collision determination, the processor apparatus outputs a collision signal to an output apparatus that performs any one or more of a variety of predetermined operations responsive to the collision signal. The operations can include reducing an engine speed of the forklift, reducing the velocity of the forklift, operating a movement mechanism to move the forklift platform away from the object or structure, producing audible and/or visual indications of the potential for a collision, and the like.

Accordingly, an aspect of the disclosed and claimed concept is to provide an improved detection system that is structured to detect the proximity of objects and structures that are situated in the vicinity of the forklift, that is also structured to make a determination that a likelihood of a collision with an object or structure has reached a predetermined threshold, and is further structured to responsively output a collision signal that causes an output apparatus to perform one or more predetermined operations responsive to the collision signal.

Another aspect of the disclosed and claimed concept is to provide an improved forklift apparatus that includes a forklift upon which such a detection system is implemented.

These and other aspects of the disclosed and claimed concept are provided by an improved detection system structured for use on a transportation vehicle having a platform apparatus, the platform apparatus having a platform and a movement mechanism that is structured to move the platform with respect to the transportation vehicle, the transportation vehicle being steerably movable and being structured to carry the platform in a forward direction and a rearward direction, the movement mechanism having at least one of a lift mechanism that is structured to lift at least a portion of the platform along a lifting direction that is substantially transverse to the forward and rearward directions and a translation mechanism that is structured to move at least a portion of the platform in a lateral direction that is substantially transverse to the forward and rearward directions. The detection system can be generally stated as including a sensor apparatus comprising a number of sensors that are structured to be situated on the platform apparatus, the number of sensors being structured to detect a proximity of an object or structure that is proximate the platform and being further structure to responsively output a number of sensor signals that are at least in part representative of the proximity, a processor apparatus that is structured to detect the number of sensor signals, the processor apparatus being further structured to make a determination based at least in part upon the number of sensor signals that a risk of a potential collision between the platform and the object or structure has reached a predetermined threshold and to responsively output a collision signal, and an output apparatus that is structured to receive the collision signal and that is further structured to perform a predetermined operation responsive to the collision signal.

### BRIEF DESCRIPTION OF THE DRAWINGS

A further understanding of the disclosed and claimed concept can be gained from the following Description when read in conjunction with the accompanying drawings in which:

FIG. 1 is a schematic depiction of an improved detection system in accordance with the disclosed and claimed concept;

FIG. 2 is a schematic depiction of an improved forklift apparatus that employs the detection system of FIG. 1 and which is depicted as being situated in an environment that includes an angled ramp which the forklift apparatus will traverse;

FIG. 3 is a top plan view of the forklift apparatus in proximity to an exemplary structure that is situated lateral to the forklift apparatus and with which a collision may become imminent;

FIG. 4 is another schematic depiction of the detection system of FIG. 1; and

FIG. 5 is a flowchart depicting certain aspects of an improved method in accordance with the disclosed and claimed concept.

Similar numerals refer to similar parts throughout the specification.

### DESCRIPTION

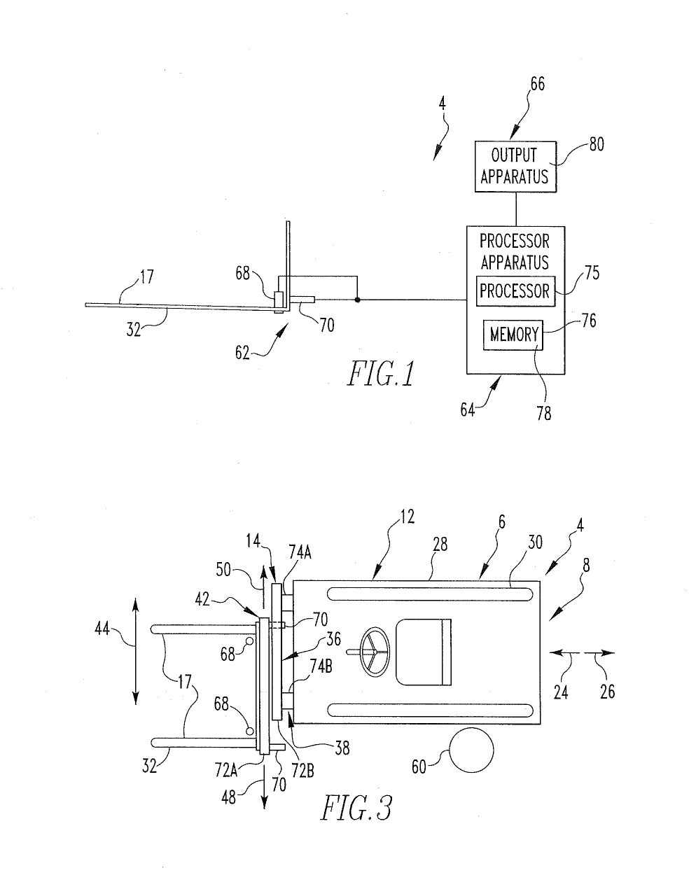

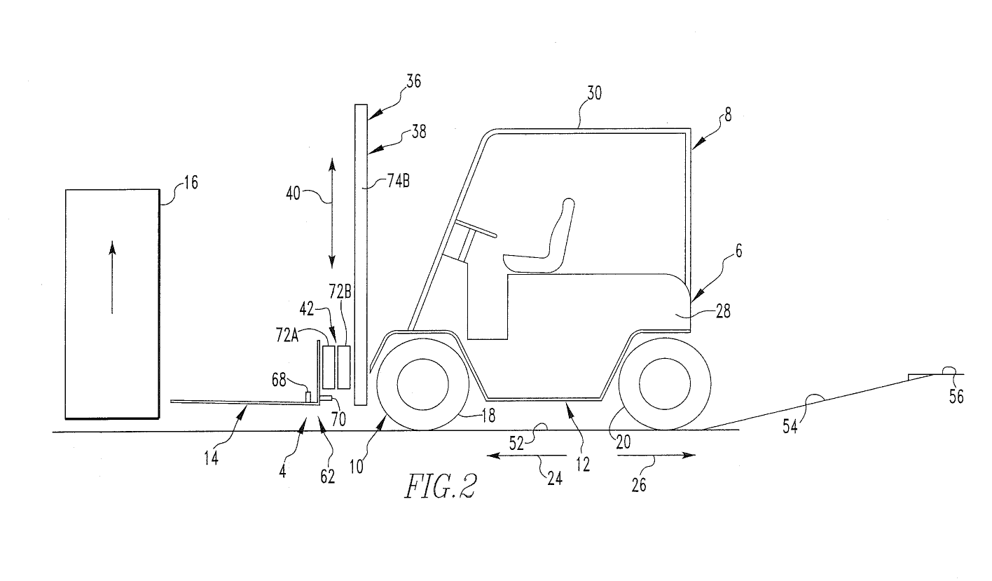

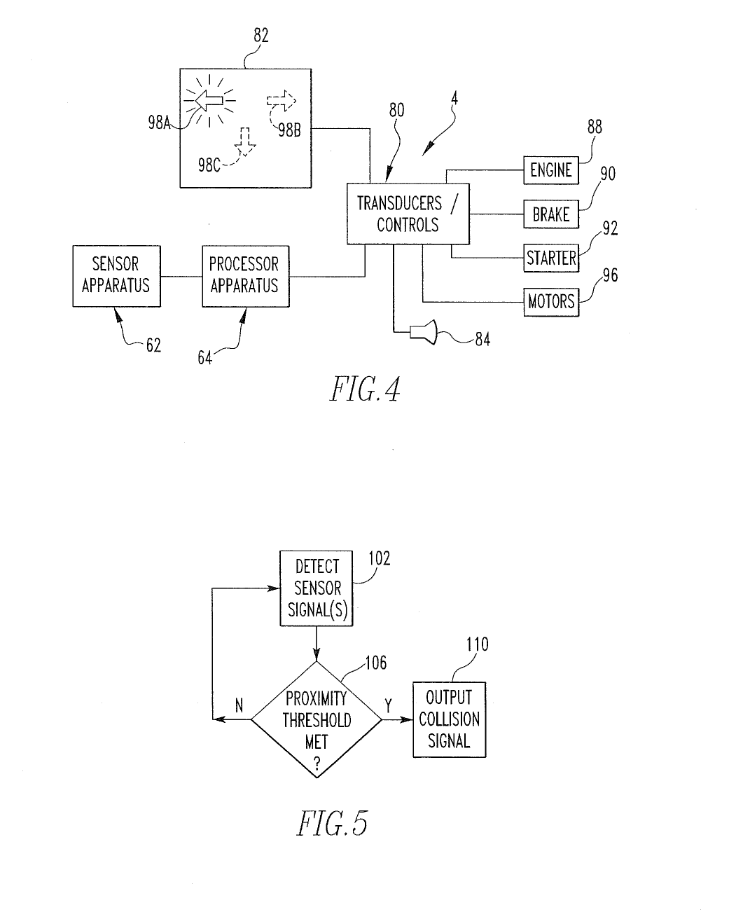

An improved detection system 4 in accordance with the disclosed and claimed concept is depicted schematically in FIGS. 1 and 4 and is depicted in conjunction with a transportation vehicle that is in the exemplary form of a forklift 6 in FIGS. 2 and 3 to form an improved transportation vehicle apparatus in the exemplary form of a forklift apparatus 8 that is likewise in accordance with the disclosed and claimed concept. The forklift 6 can be any of a wide variety of known forklift trucks and includes a drivetrain 10, a chassis 12 situated upon the drivetrain 10, and a platform apparatus 14 situated upon the chassis 12. The forklift 6 is operable to lift an article 16 above a floor or other support surface and to transport the article 16 from one location to another as needed. As is generally understood in the relevant art, the article 16 typically will include a pallet upon which a load is situated, with pallet having holes that enable a set of forks 17 of the forklift 6 to be received therein in order to enable lifting of the object 16.

The drivetrain 10 can be said to include a set of front wheels 18 and a set of rear wheels 20, with the front wheels 18 and/or the rear wheels 20 being steerable. The drivetrain 10 further includes other known elements such as an engine, a starter, a transmission, a set of brakes, and the like without limitation. The drivetrain 10 is operable to steerably move the forklift 6 in a forward direction 24 and in a rearward direction 26. The forward direction 24 is typically in the direction of the platform apparatus 14 from the chassis 12, and the rearward direction 26 is opposite thereto. The chassis 12 can be said to include a frame upon which is disposed a body 28 and a cage 30, among other known structures.

The platform apparatus 4 includes a platform 32 and a movement mechanism 36. The movement mechanism 36 is mounted to the chassis 12, and platformthe platform 32 is mounted to the movement mechanism 36. As can be understood from FIGS. 2 and 3, the platform 32 protrudes in the forward direction 24 from the movement mechanism 36 and includes the set of forks 17 that engage the article 16 and/or lift the article 16 above whatever floor or support upon which the article 16 is situated.

The movement mechanism 36 can be said to include a lift mechanism 38 that is operable to move the platform 32 along a lifting direction 40 which is generally in the vertical, i.e., upward and downward, directions when the forklift 6 is situated on a horizontal surface. The movement mechanism 36 further includes a translation mechanism 42 that is operable to move the platform 32 along the lateral direction 44 that is depicted generally in FIG. 3 and that can be said to include a leftward direction 48 and a rightward direction 50. The lifting direction 40 and the lateral direction 44 are each generally transverse to the forward and rearward directions 24 and 26 and are generally transverse to one another.

As can be understood from FIGS. 2 and 3, the translation mechanism 42 is motor operated includes a pair of schematically depicted supports 72A and 72B that are capable of gear driven or hydraulically driven translation in the lateral direction 44. The platform 32 is mounted to the support 72A and the support 72B is mounted to a pair of masts 74A and 74B of the lift mechanism 30. The supports 72A and 72B are mechanically connected together in a fashion that is not expressly depicted herein, but it is understood that the translation mechanism 42 is operable to translate the platform 32 along the lateral direction 44 with respect to the masts 74A and 74B.

As suggested above, the forklift apparatus 8 is depicted in FIG. 2 as being situated upon a first surface 52 that may be, for instance, a floor surface of a truck bed. FIG. 2 further depicts an inclined surface 54 in the exemplary form of angled dock leveler that is depicted as extending in an angled direction between the first surface 52 and a second surface 56 which may be, for example, a floor surface of a loading dock 56. The first and second surfaces 52 and 56 are depicted in FIG. 2 as each being horizontal, and as being generally parallel with one another but being offset from one another in the vertical direction from the perspective of FIG. 2. The arrangement of the first, second, and inclined surfaces 52, 56, and 54 may have the potential to create a risk of collision with the forklift apparatus 8.

The improved forklift apparatus 8 is depicted in a different environment in FIG. 3 and as being situated adjacent an objection 80 that is disposed in the leftward direction 48 from the side of the body 28. The exemplary object 60 is in the form of a vertical post that extends in the vertical direction upward from the floor upon which the forklift apparatus 8 is situated, although the object 60 can be any type of object or structure without limitation. The presence of the object 60 in proximity to the forklift apparatus 8 may have the potential to create another risk of collision with the forklift apparatus 8.

As can be understood from FIG. 1, the detection system 4 can be said to include a sensor apparatus 62, a processor apparatus 64, and an output apparatus 66. The sensor apparatus 62 in the depicted exemplary embodiment includes a number of sensors that may be of any type or configuration that is configured to output a signal that is at least in part indicative of a proximity of an object or structure to the sensor and can include, by way of example, time of flight sensing devices and other devices without limitation. As employed herein, the expression “a number of” and variations thereof shall refer broadly to any non-zero quantity, including a quantity of one. The exemplary sensor apparatus 62 are depicted herein as including one or more first sensors 68 and one or more second sensors 70, all of which are mounted on the forks 17, although they could be elsewhere positioned without departing from the present concept. The exemplary first sensors 68 are depicted in FIG. 1 as being generally downwardly-directed, i.e., directed at the region below the forks 17, which is the region that is situated generally between the forks 17 and whatever floor or other structure is situated vertically below the forks 17. It is noted that the first sensors 68 are depicted in a schematic fashion in FIG. 1 for purposes of illustration as slightly protruding below the forks 17. It is understood, however, that the first sensors 68 typically will not protrude vertically below the forks 17 and rather will typically at most be mounted flush with an undersurface of the forks 17. The first sensors 68 may be mounted as depicted in FIG. 3 to the inboard surfaces of the forks while being downwardly-directed. The second sensors 70 are depicted in FIGS. 2 and 3 as being a pair of sensors that are situated generally at the vertically lowest and most outboard positions on the forks 17 and as being directed generally in the rearward direction 26 from the platform 32.

In this regard, it can be understood that the second sensors 70 are directed in a direction generally toward a region that is situated in the rearward direction 26 from the platform 32 and that is situated lateral to the body 28. The second sensors 70 are configured to not interfere with or be interfered with by the support 72A, despite the schematic depiction of the second sensors 70 in FIG. 3.

The exemplary processor apparatus 64 includes a processor 75 that is in communication with an array of memory 76 which has stored therein a set of instructions 78 that are executable on the processor 75. The processor 75 can be any of a wide variety of processors and microprocessors without limitation. The memory 76 can likewise be any of a wide variety of storage structures, such as RAM, ROM, EEPROM, and the like and may be either volatile or non-volatile as needed. The instructions 78 are in the form of one or more routines that are stored in the memory 76 and that executable on the processor 75 to cause the processor 75 to trigger and initiate other portions of the forklift apparatus 8 to perform one or more pre-determined operations, as will be set forth in greater detail below. The processor includes one or more input terminals that are connected with the sensor apparatus 62 and which receives and processes sensor signals that are received therefrom.

The output apparatus 66 can be said to include one or more transducers or controllers or both, all of which are indicated generally with the numeral 80, and which are connected to one or more output terminals on the processor 75. The transducers/controllers 80 may include, for instance, a graphical display card or circuit that is operable to control a visual display 82 that provides a visible signal that can be seen and thus detected by an operator of the forklift apparatus 8. Similarly, the transducers/controllers 80 may include a relay mechanism that is operable to energize an audible output that is in the exemplary form of a horn 84 that provides an audible signal that can be detected by the operator of the forklift apparatus 8. Furthermore, the transducers/controllers 80 can include a throttle controller that is operable to reduce the operating speed of an engine 88 of the drivetrain 10 or to switch the engine 88 from an ON condition to an OFF condition. Moreover, the transducers/controllers 80 can include a brake controller that is operable to engage a brake 90 of the drivetrain 10 to reduce the velocity of the forklift apparatus 8 in the forward and rearward directions 24 and 26. The transducers/controllers 80 can further include an electronic ignition interlock device that prevents a starter 92 of the drivetrain 10 from starting the engine 88 from an OFF condition to an ON condition. Furthermore, the transducers/controllers 80 can include one of more motor controllers that control the operation of a set of motors 96 of the movement mechanism 36 and that can be energized to operate the lift mechanism 38 and the transmission mechanism 42 to move the platform 32 in the lifting and lateral directions 40 and 44. It thus can be seen that the transducers/controllers 80 can include any of a wide variety of control devices, including devices that are not expressly depicted herein, that can be used to operate other devices or that perform other predetermined operations without departing from the present concept.

In operation, the sensor apparatus 62 is substantially continuously detecting the proximity of any objects or structures that are situated in the vicinity of the forklift apparatus 8. In this regard, the proximity of an object with respect to the platform 32 will typically include not only the distance of the structure or object from the platform 32, but also its direction from the platform 32. The sensor apparatus 62 may thus typically include a plurality of sensors that are oriented or directed in known directions and whose collective signals can determine the location with respect of the forklift apparatus 8 of the object or structure on a three-dimensional Cartesian grid. Such a position can be obtain by employing the parallax among the sensors or via other operations. The sensor apparatus 62 may employs one or more sensors, such as the first and second sensors 68 and 70, that detect the existence of all objects and structures that are within a predetermined vicinity of the forklift apparatus 8 and that send sensor signals to the processor apparatus 64 discern from the various sensor signals the positions of the various objects and structures on a Cartesian grid with respect to the forklift apparatus 8. Stated otherwise, the various sensors of the sensor apparatus 62 provide to the processor 75 various sensor signals that are representative of the proximity of the structure or object with respect to each such sensor, and the processor 75 employs the instructions 78 to determine a location, i.e., a set of Cartesian coordinates and/or a direction and distance from the forklift apparatus 8, of each such object or structure based upon the sensor signals. It is understood that the positions of objects and structures could be merely determined in two-dimensions using Cartesian or polar (azimuth and distance) coordinates without departing from the present concept.

Once the location with respect to the forklift apparatus 8 of each object and structure in the vicinity of the forklift apparatus 8 has been determined, the processor 75 will further use the instructions 78 to determine the relative likelihood of a collision between the forklift apparatus 8 and each such object of structure. In so doing, the processor 75 may rely solely on the position data of each such object and structure, or the processor 75 may additionally employ further data such as velocity data from the front and rear wheels 18 and 20, direction data from the position of the steering wheel or the positions of whichever of the front and rear wheels 18 and 20 is steerable, and/or may rely upon other data.

Since the first and second sensors 68 and 70 are situated on the platform 32 and thus move with the platform 32 in the lifting and lateral corrections 40 and 44, and likewise move therewith in the forward and rearward directions 24 and 26, the sensor signals from the sensor apparatus 62 that are provided to the processor apparatus 64 are reflective of an instantaneous position at any given moment of the platform 32 with respect to the various object and structures that are situated in its vicinity. As such, an object that is situated in the leftward direction with respect to the platform apparatus 32 will be detected as having a closer proximity to the platform 32 if the platform 32 is itself translated in the leftward direction 48 with respect to the forklift apparatus 8 than if the platform 32 is in a center position, by way of example. Furthermore, by mounting the various sensors of the sensor apparatus 62 to the platform 32, the sensor apparatus 62 can advantageously constantly monitor and provide sensor signals to the processor apparatus 64 that are representative of any and all structures or objects that may be coming into closer proximity with any portion of the platform 32, such as when the forklift apparatus 8 is in motion. This is depicted in FIG. 5 wherein signal detection occurs at 102, a determination is made at 106 if a proximity threshold that is indicative of a collision is met. If the proximity threshold is not met, processing continues as at 104. If the proximity threshold is determined at 106 to have been reached or exceeded, i.e., the threshold is met, a collision signal is output as at 110.

The processor apparatus 64 employs the sensor signals from the sensor apparatus 62 and determines therefrom a likelihood of a collision between the forklift apparatus 8 and any such object or structure. An object or structure that is determined to have, say, a far proximity (i.e., a great distance) with respect to the platform 32 or other portions of the forklift apparatus 8 will likely be assigned a relatively low likelihood of a collision with the forklift apparatus 8. However, as the proximity of such an object or structure is determined by the sensor apparatus 62 and the processor apparatus 64 to be progressively coming relatively closer to the forklift apparatus 8, the likelihood of a collision with the object or structure is increased based upon the instructions 78. If the likelihood of a collision reaches or exceeds a predetermined threshold that is indicative of a likely collision, the processor apparatus 64 will issue a collision output that is detected by the output apparatus 66 which responsively causes one or more predetermined actions to occur. The processor apparatus 64 and/or the output apparatus 66 may additionally employ logic to determine, based upon the location and distance of the object with respect to the forklift apparatus 8, which of any one or more of a variety of predetermined actions may be taken. For instance, and as is depicted generally in FIG. 3, if the proximity of the object 60 is determined to be relatively distant from the platform 32 based upon the velocity and direction of the drivetrain 10, the output apparatus 66 may employ a transducer or controller 80 that controls the throttle on the engine 88 and causes the engine 88 to be reduced in engine speed. As the proximity of the object 60 to the platform 32 increases, such as if the operator of the forklift did not take remedial action in response to the reduced engine speed, the output apparatus 66 may further trigger one of its controllers 80 to energize the horn 84 to generate an audible signal and/or may additionally trigger another controller 80 to cause it to provide a visual signal in the form of one or more indicators 98A, 98B, and 98C which output on the visual display 82 an indication that is representative of the general direction of the object 60 with respect to the forklift apparatus 8. Other variations will be apparent.

For example, the output apparatus 66 may trigger one of its controllers 80 to switch the engine 88 to an OFF condition and may additionally prevent the starter 92 from starting the engine 88 from the OFF condition to an ON condition unless the object 60 has been removed from proximity to the forklift apparatus 8. Additionally or alternatively, a controller 80 in the form of a brake controller may actuate the brake 90 to slow the forklift apparatus 8 or to stop it entirely, and the braking force may be dependent upon the velocity of the forklift apparatus 8 and the proximity of the object or structure. Further alternatively or additionally, one or more of the transducers/controllers 80 may control the motors 96 that operate the lift mechanism 38 and the transmission mechanism 42 to move the platform 32 in a lifting direction 40 and/or the lateral direction 44 until the likelihood of a collision has been reduced to a value below the predetermined threshold. Again, the likelihood of a collision is constantly reevaluated by the processor apparatus 64 and is determined to based upon an instantaneous set of sensor outputs from the sensor apparatus 62 that are representative of an instantaneous position of the object or structure with respect to the platform 32, Other variations will be apparent.

It thus can be understood that the improved forklift apparatus 8 employs the detection system 4 with its sensor apparatus 62 and processor apparatus 64 to determine, based at least in part upon a proximity of an object or structure with respect to the forklift apparatus 8, whether a likelihood of collision with the object or structure has reached or exceeded a predetermined threshold and, if so, the output apparatus 66 is instructed to initiate one or more predetermined remedial actions. The remedial actions, individually or in combination, advantageously resist damage to the platform apparatus 14 and/or the article 16 by avoiding catastrophic collisions. By way of example, if in FIG. 3 the forklift 6 did not include the detection system 4, and if the forklift 6 driven in the rearward direction 26, the body 28 may move past the object 60 sufficiently that the portion of the support 72A and the platform 32 that are protruding in the leftward direction 48 from the body 28 may impact the object 60 and become damaged. However, the detection system 4 advantageously determines when a probability of collision has reached or exceeded a predetermined threshold and advantageously performs one or more predetermined functions or operations to remediate the likelihood of a collision.

While the sensors of the sensor apparatus 62 have been depicted in an exemplary fashion herein as including one or more first sensors 68 and one or more second sensors 70, it is understood that the sensor apparatus 62 can (in other embodiments) take many forms. For instance, the sensor apparatus may include one or more sensors that are situated on the cage 30 and that are downwardly directed into the region at the sides of the body 28, i.e., in the lateral direction 44 with respect thereto. An alternative embodiment may additionally employ data from the motors 96 or the controls thereof to determine an instantaneous position of the platform 32 along the lateral direction 44 with respect to the body 28 to determine whether or not a meaningful likelihood of a collision exists. In such a fashion, the processor apparatus 64 could potentially be configured to not include any sensors that are mounted directly to the forks 17 and would rather rely upon sensors otherwise mounted to the forklift apparatus 8. For instance, one or more sensors may additionally or alternatively be situated on the masts 74A and 74B and may be operable to determine whether or not an object or structure that is at the front or sides of the forklift apparatus 8 is likely to be in a collision between it and the forklift apparatus 8.

Numerous other configurations of sensors and sensing devices will be apparent to one of ordinary skill in the art. The detection system 4 may be provided as a part of a new forklift apparatus 8, or the detection system 4 may be sold as a kit that is retrofitted to an existing forklift 6 to form a forklift apparatus 8.

It thus can be understood that virtually any combination of sensing devices and detection devices can be employed to determine whether a meaningful potential or likelihood of a collision with the forklift apparatus 8 exists and can responsively instruct the output apparatus 66 to perform one or more predetermined actions to eliminate or at least reduce to an acceptable level the likelihood of a collision. Other advantages will be apparent to one of ordinary skill in the art.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A detection system structured for use on a transportation vehicle having a platform apparatus, the platform apparatus having a platform and a movement mechanism that is structured to move the platform with respect to the transportation vehicle, the transportation vehicle being steerably movable and being structured to carry the platform in a forward direction and a rearward direction, the movement mechanism having at least one of a lift mechanism that is structured to lift at least a portion of the platform along a lifting direction that is substantially transverse to the forward and rearward directions and a translation mechanism that is structured to move at least a portion of the platform in a lateral direction that is substantially transverse to the forward and rearward directions, the detection system comprising:
a sensor apparatus comprising a number of sensors that are structured to be situated on the platform apparatus, the number of sensors being structured to detect a proximity of an object or structure that is proximate the platform and being further structure to responsively output a number of sensor signals that are at least in part representative of the proximity;
a processor apparatus that is structured to detect the number of sensor signals, the processor apparatus being further structured to make a determination based at least in part upon the number of sensor signals that a risk of a potential collision between the platform and the object or structure has reached a predetermined threshold and to responsively output a collision signal; and
an output apparatus that is structured to receive the collision signal and that is further structured to perform a predetermined operation responsive to the collision signal.

2. The detection system of claim 1 wherein the number of sensors comprise at least a first sensor that is structured to detect as said proximity a proximity of a structure that is situated at least in part underneath the platform.

3. The detection system of claim 2 wherein the at least first sensor comprises one or more sensors that are structured to be directed toward a region that is situated generally below the platform.

4. The detection system of claim 1 wherein the number of sensors comprise at least a first sensor that is structured to detect as said proximity a proximity of an object or structure that is situated in a rearward direction from at least a portion of the platform and is situated lateral to the transportation vehicle.

5. The detection system of claim 4 wherein the at least first sensor comprises one or more sensors that are structured to be directed to a region that is situated generally rearward of the platform.

6. The detection system of claim 1 wherein the output apparatus comprises at least one of:
a throttle controller that is structured to reduce an engine speed of the transportation vehicle as the predetermined operation;
a brake controller that is structured to apply a brake of the transportation vehicle as the predetermined operation;
an engine controller that is structured to switch an engine of the transportation vehicle from an ON condition to an OFF condition as the predetermined operation;
an engine controller that is structured to resist the switching of an engine of the transportation vehicle from an OFF condition to an ON condition as the predetermined operation;
a drivetrain controller that is structured to resist the transportation vehicle from moving in the rearward direction as the predetermined operation;
a platform controller that is structured to operate the movement mechanism to move the platform a sufficient distance in a direction generally away from the object or structure that the risk of a potential collision drops below the predetermined threshold;
a speed controller that is structured to reduce a velocity of the transportation vehicle as the predetermined operation;
an audible indicator that is structured to output an audible signal as the predetermined operation; and
a visual indicator that is structured to output a visible signal as the predetermined operation.

7. The detection system of claim 1 wherein the output apparatus comprises a visual indicator that is structured to perform as the predetermined operation an outputting of a visible signal that is at least in part representative of the location of the object or structure with respect to the transportation vehicle.

8. The detection system of claim 1 wherein the output apparatus comprises a platform controller that is structured to operate the movement mechanism to move the platform in at least one of the lifting direction and the lateral direction a distance sufficient that the risk of a potential collision drops below the predetermined threshold.

9. The detection system of claim 1 wherein the processor apparatus comprises a processor and a memory having stored therein instructions that are executable on the processor to cause the detection system to perform operations comprising:
detecting the number of sensor signals;
making a determination based at least in part upon the number of sensor signals that the risk of a potential collision between the platform and the object or structure has reached the predetermined threshold; and
outputting the collision signal responsive at least in part to the making of the determination.

10. A transportation vehicle apparatus comprising the detection system of claim 1 and further comprising:
a transportation vehicle having a platform apparatus;
the platform apparatus having a platform and a movement mechanism that is structured to move the platform with respect to the transportation vehicle;
the transportation vehicle being structured to be steerably movable and being structured to carry the platform in a forward direction and a rearward direction;
the movement mechanism having at least one of:
a lift mechanism that is structured to lift at least a portion of the platform along a lifting direction that is substantially transverse to the forward and rearward directions, and a translation mechanism that is structured to move at least a portion of the platfoil in a lateral direction that is substantially transverse to the forward and rearward directions.

11. The transportation vehicle of claim 10 wherein the movement mechanism comprises both the lift mechanism and the translation mechanism, and wherein the lifting direction and the lateral direction are generally transverse to one another.
